(19) United States
(12) Patent Application Publication
(10) Pub. No.: US 2015/0362653 A1
(43) Pub. Date: Dec. 17, 2015

(54) BACKLIGHT MODULE

(71) Applicant: Shenzhen China Star Optoelectronics Technology Co., Ltd., Shenzhen (CN)

(72) Inventor: Jianyu Chang, Shenzhen (CN)

(73) Assignee: Shenzhen China Star Optoelectronics Technology Co., Ltd., Shenzhen (CN)

(21) Appl. No.: 14/374,531

(22) PCT Filed: Jul. 2, 2014
(86) PCT No.: PCT/CN2014/081436

§ 371 Date: Jul. 25, 2014

(30) Foreign Application Priority Data
Jun. 17, 2014 (CN) 201410271312.6

(51) Int. Cl. F21V 8/00

(52) U.S. Cl. CPC G02B 6/0021; G02B 6/005; G02B 6/0043; G02B 6/0073

(57) ABSTRACT

A backlight module includes a backplane, a light guide plate in the backplane, and at least a backlight source in the backplane. The backplane includes a bottom plate. The light guide plate is formed with at least a groove corresponding to the at least a backlight source at a location near a side edge of the light guide plate. An opening of the at least a groove is towards the bottom plate. The at least a backlight source is installed on the bottom plate of the backplane and correspondingly arranged in the at least a groove. A side of the at least a groove near the side edge of the light guide plate is formed with a side reflective sheet. The backlight module can improve the light coupling efficiency and light utilization, achieve the reduction of energy consumption and cost down, and is suitable for large-sized LCD device.

### TECHNICAL FIELD

The present invention relates to the field of liquid crystal display, and particularly to a backlight module.

### DESCRIPTION OF RELATED ART

The liquid crystal display (LCD) device has advantages of slim body, electricity-saving and radiation free, etc. and thus has been widely used. Such as mobile phones, personal digital assistants (PDA), digital cameras, desktop or laptop computer screens, and so on.

On the current market, most of LCD devices are backlight-type LCD devices. The backlight-type LCD device includes a housing, a liquid crystal panel arranged in the housing and a backlight module arranged in the housing. A conventional structure of the liquid crystal panel is constituted by a color filter substrate, a thin film transistor (TFT) array substrate, and a liquid crystal layer sandwiched between the two substrates. An operation principle of the liquid crystal panel is controlling rotation of liquid crystal molecules of the liquid crystal layer by applying driving voltages on the two substrates and thereby refracting light rays of the backlight module outside to produce an image. Since the liquid crystal panel is non-self-emissive, a light source provided by the backlight module is necessary for normal display of image, and thereby the backlight module is one of key components of the LCD device. According to different incident positions of light source, the backlight modules are classified into edge-type backlight module and direct-type backlight module. In the direct-type backlight module, a light emitting source such as cold cathode fluorescent lamp (CCFL) or light emitting diode (LED) is arranged backside of the liquid crystal panel and directly forms a surface light source for the liquid crystal panel. In the edge-type backlight module, a backlight LED light bar is arranged at an edge of backplane of rear side of the liquid crystal panel. Light rays emitted from the LED light bar strike on a side surface of a light guide plate (LGP) and enter into the LGP, emit out from a light exiting surface of LGP after reflection and diffusion, form a surface light source after passing an optical film set, and then supply to the liquid crystal panel for illumination.

With the development of LCD technology, how to save energy and reduce energy consumption has been becoming an aim of attention for people. As to the LCD device, besides increasing the optical efficiency of the LED backlight source, the purposes of energy consumption reduction and cost down also can be achieved by improving the backlight module, using a better optical coupling design and increasing light utilization.

Referring to FIG. 1, which is a schematic cross-sectional view of a conventional edge-type backlight module. The conventional edge-type backlight module includes a backplane 100, a light guide plate 300 arranged in the backplane 100, a LED light source 500 arranged on a side plate 150 of the backplane 100 and at a side of the light guide plate 300, a plastic frame 700 arranged on the backplane 100 and above the light source 500 and the light guide plate 300, an optical film set 900 arranged on the light guide plate 300, a bottom reflective sheet 200 arranged between a bottom plate 130 of the backplane 100 and the light guide plate 300, and multiple dots 400 formed on a surface of the light guide plate 300 near the bottom plate 130 of the backplane 100. Since the light emitting angle of the LED light source 500 is large, which is about 120 degrees; some of emitted light could not directly enter into the light guide plate 300 and leak out from a gap between the LED light source 500 and the light guide plate 300. In order to reduce the loss of the light, a conventional method is to attach a reflective sheet 600 to a corresponding portion of the plastic frame 700 above the LED light source 500, so that light incident above the LED light source would be reflected back and thus the light coupling efficiency and light utilization are improved in some degree. However, when a size of the LCD device is large, the light coupling distance between the LED light source 500 and the light guide plate 300 is correspondingly large, the backlight module would still have serious light loss, for example, the reflective sheet 600 absorbs a large amount of light, light reflected by the reflective sheet 600 would be absorbed by other components, the dots 400 break internal total reflection of light in the light guide plate 300, and so on. FIG. 2 is a schematic view of light coupling efficiency of a light guide plate in a conventional edge-type backlight module. As illustrated in FIG. 2, when an light coupling distance is 0.6 millimeters (mm), the light coupling efficiency is 80%, and with the increase of the light coupling distance, the light coupling efficiency would be further decreased.

Accordingly, the conventional edge-type backlight module has a low light coupling efficiency, which goes against the reduction of energy consumption and cost down, and is not suitable for large-sized LCD device.

### SUMMARY

Accordingly, an objective of the present invention is to provide a backlight module, which can improve the light coupling efficiency and light utilization, achieve the reduction of energy consumption and cost down, and is suitable for large-sized LCD device.

In order to achieve the above objective, a backlight module according to an exemplary embodiment of the present invention includes a backplane, a light guide plate arranged in the backplane, and at least a backlight source arranged in the backplane. The backplane includes a bottom plate. The light guide plate is formed with at least a groove corresponding to the at least a backlight source at a location near a side edge of the light guide plate. An opening of the at least a groove is towards the bottom plate. The at least a backlight source is installed on the bottom plate of the backplane and correspondingly arranged in the at least a groove.

In an exemplary embodiment, a side of the at least a groove near the side edge of the light guide plate is arranged with a side reflective sheet, and the backplane further includes a side plate perpendicularly connected to the bottom plate.

In an exemplary embodiment, the backlight module further includes an optical film set arranged on the light guide plate and a plastic frame arranged on the side plate of the backplane and above the light guide plate.

In an exemplary embodiment, the backlight module further includes a bottom reflective sheet arranged between the light guide plate and the bottom plate, the bottom reflective sheet is formed with a through hole corresponding to the at least a backlight source for allowing the at least a backlight source to penetrate through the through hole.

In an exemplary embodiment, a surface of the light guide plate is arranged with multiple dots, and the at least a groove is formed at the location near the side edge and outside a visible region of the light guide plate.

In an exemplary embodiment, the at least a backlight source is a LED light bar.

In an exemplary embodiment, the at least a groove has an inverted V-shape or arc-shape.

The light guide plate is integrally formed by injection molding.

In an exemplary embodiment, the side reflective sheet is arranged at the side of the at least a groove near the side edge of the light guide plate by coating.

In an exemplary embodiment, the side reflective sheet is arranged at the side of the at least a groove near the side edge of the light guide plate by attaching.

The present invention further provides a backlight module including a backplane, a light guide plate housed in the backplane, and at least a backlight source housed in the backplane. The backplane includes a bottom plate. The light guide plate is formed with at least a groove corresponding to the at least a backlight source at a location near a side edge of the light guide plate. An opening of the at least a groove is towards the bottom plate. The at least a backlight source is installed on the bottom plate of the backplane and correspondingly arranged in the at least a groove.

The at least a groove is arranged with a side reflective sheet at a side thereof near the side edge of the light guide plate. The backplane further includes a side plate perpendicularly connected to the bottom plate.

The backlight module further includes an optical film set arranged on the light guide plate and a plastic frame arranged on the side plate of the backplane and above the light guide plate.

The backlight module still further includes a bottom reflective sheet arranged between the light guide plate and the bottom plate. The bottom reflective sheet is formed with a through hole corresponding to the at least a backlight source for allowing the at least a backlight source to penetrate through.

A surface of the light guide plate is arranged with multiple dots. The at least a groove is formed at the location near the side edge and outside a visible region of the light guide plate.

The at least a backlight source is a LED light bar.

The at least a groove has an inverted V-shape.

The light guide plate is integrally formed by injection molding.

The side reflective sheet is arranged at the side of the at least a groove near the side edge of the light guide plate by attaching.

Beneficial effects can be achieved by the present invention are that: the backlight module of the present invention, by forming at least a groove at a location outside the visible region and near the side edge of the light guide plate, housing the at least a backlight source in the at least a groove and arranging a side reflective sheet at a side of the at least a groove near the side edge of the light guide plate, the light loss caused by an increased light coupling distance can be reduced, much more light emitted from the at least a backlight source can be coupled into the visible region, and therefore the light coupling efficiency and light utilization can be improved, reduction of energy consumption and cost down are achieved, and the backlight module is suitable for large-sized LCD device.

### BRIEF DESCRIPTION OF THE DRAWINGS

In order to better understand characteristics and technical aspects of the present invention, please refer to the following detailed description with reference to accompanying drawings of the present invention. However, the accompanying drawings are presented herein for purpose of illustration and description only, and it is not intended to limit the present invention.

FIG. 1 is a schematic cross-sectional view of a conventional edge-type backlight module.

FIG. 2 is a schematic view of relationship of light coupling efficiency of a light guide plate in a conventional edge-type backlight module.

FIG. 3 is schematic cross-sectional view of a backlight module according to a first embodiment of the present invention.

FIG. 4 is an enlarged schematic cross-sectional view of a light guide plate, backlight sources, reflective sheets and dots according to the first embodiment of the present invention.

FIG. 5 is a schematic cross-sectional view of a backlight module according to a second embodiment of the present invention.

FIG. 6 is an enlarged schematic cross-sectional view of a light guide plate, backlight sources, reflective sheets and dots according to the second embodiment of the present invention.

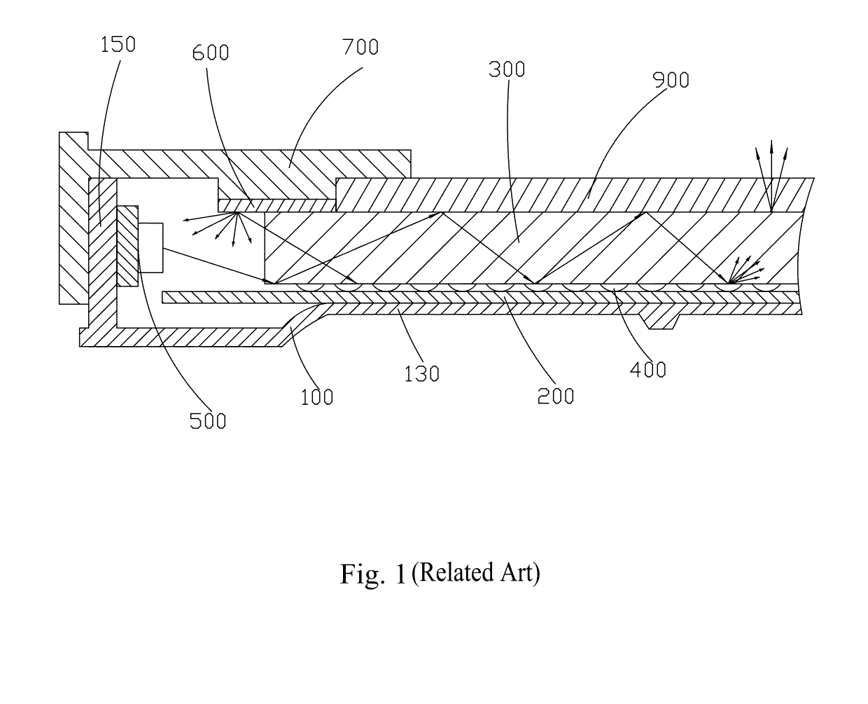

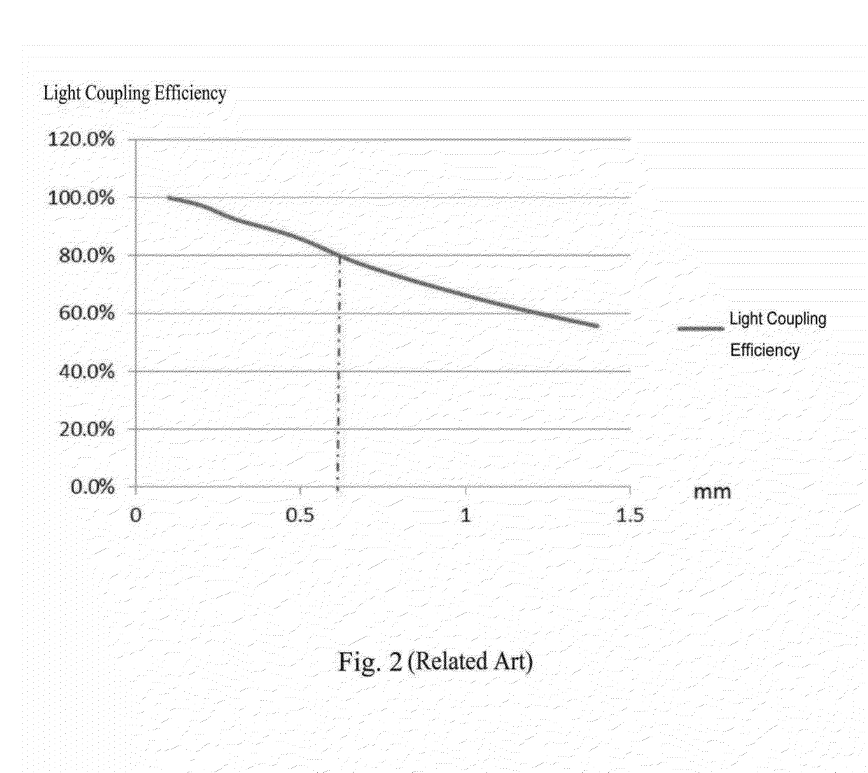

### DETAILED DESCRIPTION OF EMBODIMENTS

In order to further illustrate technical means adopted by the present invention and technical effects thereof, preferred embodiments of the present invention will be described below in detail with reference to accompanying drawings.

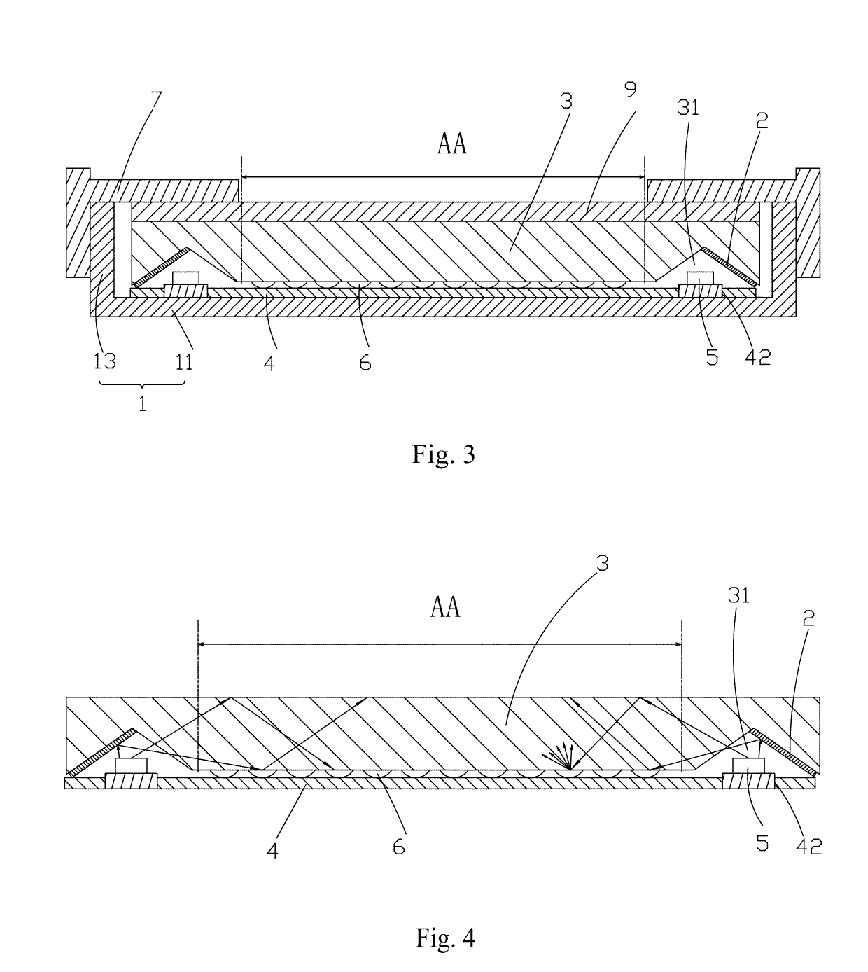

Referring to FIGS. 3 and 4, which are schematic views of a backlight module according to a first embodiment of the present invention. The backlight module includes a backplane 1, a light guide plate 3 arranged in the backplane 1, and two backlight sources 5 arranged in the backplane 1. It is understood that the amount of the backlight sources 5 may be one or even more than two instead. The backplane 1 includes a bottom plate 11 and a side plate 13 vertically/perpendicularly connected to the bottom plate 11. The light guide plate 3 is formed with two grooves 31 corresponding to the two backlight sources 5 at locations respectively near two side edges of the light guide plate 3. In other words, the two grooves 31 are formed at the bottom surface of the light guide plate 3. Openings of the grooves 31 are towards the bottom plate 11. The backlight sources 5 are installed/disposed on the bottom plate 11 of the backplane 1 and correspondingly located in the grooves 31. It is understood that, the amount of the grooves 31 are matched with the backlight sources 5 and thus also may be one or even more than two instead.

Moreover, each groove 31 is arranged at a location near the side edge of the light guide plate 3 and outside a visible region i.e., AA region of the light guide plate 3.

A side of each groove 31 near the side edge of the light guide plate 3 is arranged with a side reflective sheet 2. The backlight sources 5 are arranged in the grooves 31, which can avoid the influence of an increased light coupling distance caused by an increase of size of LCD device, the light loss caused by the increased light coupling distance is reduced, and thus much more light emitted from the backlight sources 5 can enter into the light guide plate 3. Meanwhile, the side reflective sheets 2 arranged at the side of the grooves near the side edges of the light guide plate 3 can reflect the light which is going to incident on the side edges of the light guide plate 3 to enter into the light guide plate 3, and prevent some light to leak out from the side edges of the light guide plate 3 outside the AA region. In one aspect, much more light emitted from the backlight sources 5 can be coupled into the AA region, the light coupling efficiency and light utilization can be further improved and the light loss can be reduced. In another aspect, the problem of light leakage at the edge of LCD device can be avoided and thus the display quality is improved consequently.

The backlight module further includes an optical film set 9 arranged on the light guide plate 3, a plastic frame 7 arranged on the side plate 13 and above the light guide plate 3, a bottom reflective sheet 4 arranged between the light guide plate 3 and the bottom plate 11, and multiple dots 6 formed on a surface of the light guide plate 3 near the bottom plate 11, i.e., a bottom surface of the light guide plate 3.

The bottom reflective sheet 4 is formed with through holes 42 respectively corresponding to the backlight sources 5 for allowing the backlight sources 5 to penetrate therethrough.

In the first embodiment, each groove 31 has an inverted V-shape.

The side reflective sheets 2 can be formed by coating on the sides of the grooves 31 respectively near the side edges of the light guide plate 3.

The side reflective sheets 2 can be formed by attaching on the sides of the grooves 31 respectively near the side edges of the light guide plate 3 instead.

The light guide plate 3 can be integrally formed by injection molding, or is formed by firstly injection molding the main body of the light guide plate 3 and then machining the grooves 31 by mechanical machining or other manner instead. Preferably, the light guide plate 3 is integrally formed by injection molding.

The backlight sources 5 each are a LED light bar. The LEDs in the light bar can use a vertical picking and placing manner, or use a traditional picking and placing manner.

The dots 6 can diffuse light and adjust distribution of light to thereby make the light more uniform. The dots 6 each may have a shape of semicircle, semiellipse, triangular pyramid, or quadrangular pyramid, and so on. The dots 6 can be formed by printing or injection molding, and so on.

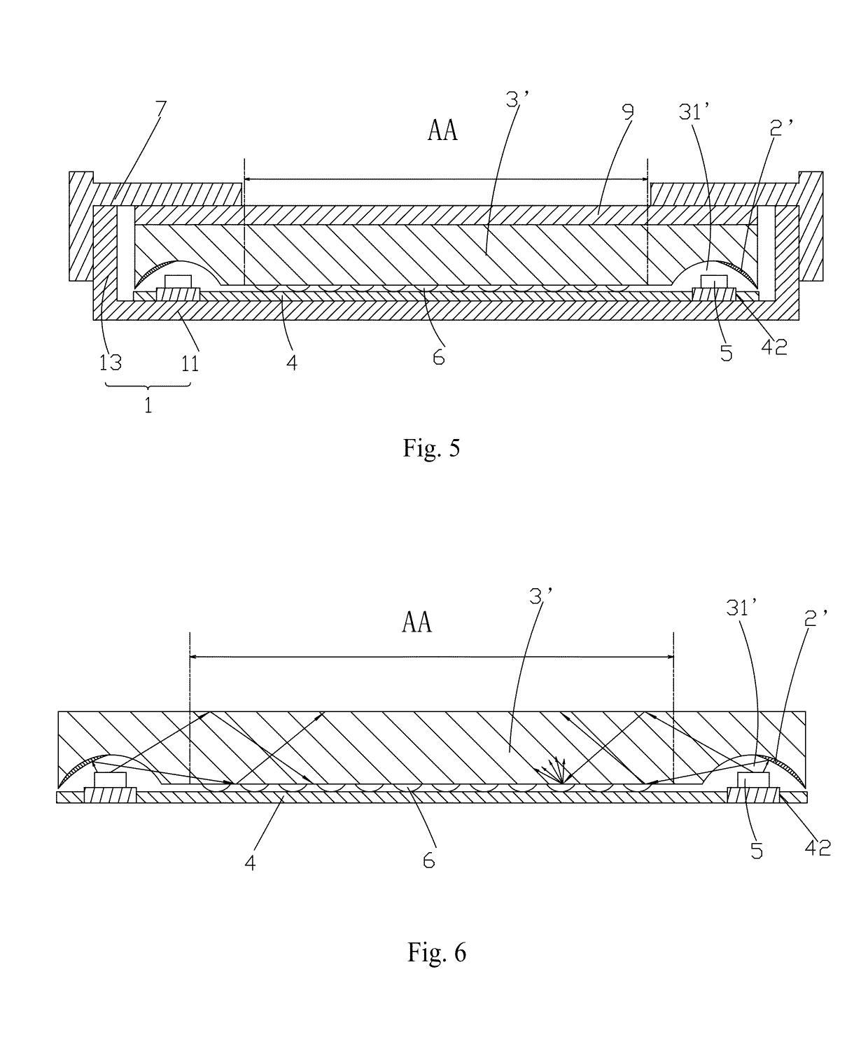

Referring to FIGS. 5 and 6, which are schematic views of a backlight module according to a second embodiment of the present invention. A difference of the second embodiment from the above-mentioned first embodiment is that: the light guide plate 3′ is formed with grooves 31′ respectively at locations near two side edges of the light guide plate 3′ and outside the AA region, and the shapes of the grooves are arc-shaped. Herein, the AA region generally is a region not covered by the plastic frame 7. Other parts of the second embodiment are the same as that of the first embodiment, and thus will not be repeated herein.

In summary, the backlight module of the present invention, by forming at least a groove at a location outside the visible region and near the side edge of the light guide plate, housing the at least a backlight source in the at least a groove and arranging a side reflective sheet at a side of the at least a groove near the side edge of the light guide plate, the light loss caused by an increased light coupling distance can be reduced, much more light emitted from the at least a backlight source can be coupled into the visible region, and therefore the light coupling efficiency and light utilization can be improved, reduction of energy consumption and cost down are achieved, and the backlight module is suitable for large-sized LCD device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module comprising: a backplane, a light guide plate arranged in the backplane, and at least a backlight source arranged in the backplane;
wherein the backplane comprises a bottom plate, the light guide plate is formed with at least a groove corresponding to the at least a backlight source at a location near a side edge of the light guide plate, an opening of the at least a groove is towards the bottom plate, the at least a backlight source is installed on the bottom plate of the backplane and correspondingly arranged in the at least a groove.

2. The backlight module as claimed in claim 1, wherein a side of the at least a groove near the side edge of the light guide plate is arranged with a side reflective sheet, and the backplane further comprises a side plate perpendicularly connected to the bottom plate.

3. The backlight module as claimed in claim 2, further comprising an optical film set arranged on the light guide plate, and a plastic frame arranged on the side plate of the backplane and above the light guide plate.

4. The backlight module as claimed in claim 1, further comprising a bottom reflective sheet arranged between the light guide plate and the bottom plate, wherein the bottom reflective sheet is formed with a through hole corresponding to the at least a backlight source for allowing the at least a backlight source to penetrate therethrough.

5. The backlight module as claimed in claim 1, wherein a surface of the light guide plate near the bottom plate is formed with a plurality of dots, and the at least a groove is arranged at the location near the side edge and outside a visible region of the light guide plate.

6. The backlight module as claimed in claim 1, wherein the at least a backlight source is a LED light bar.

7. The backlight module as claimed in claim 1, wherein the at least a groove has an inverted V-shape or arc-shape.

8. The backlight module as claimed in claim 1, wherein the light guide plate is integrally formed by injection molding.

9. The backlight module as claimed in claim 2, wherein the side reflective sheet is arranged at the side of the at least a groove near the side edge of the light guide plate by coating.

10. The backlight module as claimed in claim 2, wherein the side reflective sheet is arranged at the side of the at least a groove near the side edge of the light guide plate by attaching.

11. A backlight module comprising a backplane, a light guide plate housed in the backplane, and at least a backlight source housed in the backplane; wherein the backplane comprises a bottom plate, the light guide plate is formed with at least a groove corresponding to the at least a backlight source at a location near a side edge of the light guide plate, an opening of the at least a groove is towards the bottom plate, the at least a backlight source is disposed on the bottom plate of the backplane and correspondingly located in the at least a groove;
wherein a side of the at least a groove near the side edge of the light guide plate is arranged with a side reflective sheet, and the backplane further comprises a side plate perpendicularly connected to the bottom plate;
wherein the backlight module further comprises an optical film set arranged on the light guide plate, and a plastic frame arranged on the side plate of the backplane and above the light guide plate;
wherein the backlight module still further comprises a bottom reflective sheet arranged between the light guide plate and the bottom plate, the bottom reflective sheet is formed with a through hole corresponding to the at least a backlight source for allowing the at least a backlight source to penetrate therethrough;
wherein a surface of the light guide plate near the bottom plate is arranged with a plurality of dots, and the at least a groove is arranged at the location near the side edge and outside a visible region of the light guide plate;
wherein the at least a backlight source is a LED light bar;
wherein the at least a groove has an inverted V-shape;
wherein the light guide plate is integrally formed by injection molding;
wherein the side reflective sheet is arranged at the side of the at least a groove near the side edge of the light guide plate by attaching.
